(19) United States
(12) Patent Application Publication
(10) Pub. No.: US 2018/0051142 A1
(43) Pub. Date: Feb. 22, 2018

(54) METHOD AND SYSTEM OF PRODUCING FIBER REINFORCED PLASTIC

(71) Applicants: Mahdi Soltanpour, Karaj (IR); Saeed Goodarzvand, Ghazvin (IR); Ali Fazli, Ghazvin (IR); Farzin Kazemi Taskooh, Masal (IR)

(72) Inventors: Mahdi Soltanpour, Karaj (IR); Saeed Goodarzvand, Ghazvin (IR); Ali Fazli, Ghazvin (IR); Farzin Kazemi Taskooh, Masal (IR)

(21) Appl. No.: 15/800,053

(22) Filed: Oct. 31, 2017

(30) Foreign Application Priority Data
Nov. 4, 2016 (IR) 13955014000300973

(51) Int. Cl. C08J 5/04; B32B 27/08; C08K 3/08

(52) U.S. Cl. CPC C08J 5/042; B32B 27/08; C08K 3/08; C08K 2003/085; C08K 2003/0812; C08K 2003/0881; C08J 2300/24

(57) ABSTRACT

An improved system and method of producing fiber-reinforced polymer composites is disclosed. In one implementation, the improved process involves placing pieces of metal components between layers of fiber during the layering and impregnating process. The impregnated layers are then placed into a die/mold to form a fiber-reinforced polymer composite part. Because of the use of metal components, the fiber-reinforced polymer composite can be removed from the die/mold while only semi-cured. Thus, the solution provided by the preferred embodiment of the present invention increases the speed of production thereby increasing production efficiency, reducing the cost, and resulting in a higher quality final product.

### CROSS REFERENCE TO RELATED APPLICATION

This application claims the benefit of priority to an Iran patent application having serial number 139550140003009732, which was filed on Nov. 4, 2016, and is incorporated by reference herein in its entirety.

### TECHNICAL FIELD

The present application relates generally to methods of producing fiber reinforced plastic (FRP), and more particularly to an improved method of producing fiber reinforced plastic composites configured to increase production rate and efficiency.

### BACKGROUND

In recent years, the use of fiber composites and in particular carbon fiber composites, has increased significantly. This is due, in part, to the advantageous properties these materials exhibit. For example, most fiber-reinforced composites exhibit high strength, low density, high corrosion resistance, dimensional stability and high vibration absorption, among others. The most important advantage of fiber-reinforced composite materials is their light weight despite their high strength. This makes fiber composite materials particularly useful in manufacturing moving devices, such as vehicles, as their use reduces the overall weight of the vehicle, resulting in lower fuel consumption and lower environmental pollution.

Despite their advantageous properties, fiber composite materials are still not commonly used in cars. This is in part, due to the high cost associated with production of these materials. In general, production with fiber composite materials takes a lot longer than production with most metals. This leads to an increase in the cost of the produced parts and thus the overall cost of the product. As a result, these materials are mostly used in the military, aerospace industries or other industries that produce expensive products, and their use is not common in lower cost products.

Therefore, a need exists for providing an improved system and method for producing fiber composite materials.

### SUMMARY

A method for producing a fiber-reinforced composite part is provided. In one implementation, the method for producing a fiber-reinforced composite part includes placing a plurality of fibers and at least one metal component in one or more layers, impregnating the one or more layers with at least one bonding material disposed on the one or more layers, placing the impregnated one or more layers in a die until a semi-cured fiber-reinforced composite part is formed, and removing the semi-cured fiber-reinforced composite part from the die.

In one implementation, the bonding material used in the method for producing a fiber-reinforced composite part includes a thermoset resin.

In one implementation, the method for producing a fiber-reinforced composite part includes inserting the formed semi-cured fiber-reinforced composite part into an oven to fully cure. In another implementation, method for producing a fiber-reinforced composite part includes leaving the formed semi-cured fiber-reinforced composite part in an ambient environment to fully cure. In one implementation, the method for producing a fiber-reinforced composite part includes forming the semi-cured fiber-reinforced composite part using a stamping process. In one implementation, the method for producing a fiber-reinforced composite part includes removing any excess bonding material from the one or more layers.

In one implementation, at least one of a type and dimension of the metal component used in the method for producing a fiber-reinforced composite part is selected based on one or more desired properties of the fiber-reinforced composite part.

### BRIEF DESCRIPTION OF THE DRAWINGS

Features of the subject technology are set forth in the appended claims. However, for purpose of explanation, several implementations of the subject technology are set forth in the following figures.

FIG. 1 illustrates a diagram of a cross section of a fiber-reinforced polymer composite part produced according to an implementation of the present invention.

FIG. 2 illustrates a diagram of a flow of example operations for producing a fiber-reinforced composite part, according to an implementation.

FIGS. 3A-3D illustrate schematic diagrams showing various stages of forming a fiber-reinforced composite part using a stamping process, according to an implementation.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings. As part of the description, some of this disclosure's drawings represent structures and devices in block diagram form in order to avoid obscuring the invention. In the interest of clarity, not all features of an actual implementation are described in this specification. Moreover, the language used in this disclosure has been principally selected for readability and instructional purposes, and may not have been selected to delineate or circumscribe the inventive subject matter, resort to the claims being necessary to determine such inventive subject matter. Reference in this disclosure to “one implementation” or to “an implementation” means that a particular feature, structure, or characteristic described in connection with the embodiment is included in at least one embodiment of the invention, and multiple references to “one embodiment” or “an embodiment” should not be understood as necessarily all referring to the same embodiment.

The use of fiber-reinforced polymer composites has become very popular in recent years due to features such as high strength, low density, corrosion resistance, dimensional stability and high vibration absorption. One of the most advantageous properties of these materials is their high strength. These properties make the use of fiber-reinforced polymer composites in moving devices, such as cars and aircrafts highly desirable, as their use can lower vehicle weight and thus reduce fuel consumption and environmental pollution. However, despite all their positive features, the use of these materials is not very common in practice. This is mostly because the cost of these materials is generally much higher than that of metals, which limits the use of these materials to the military, aerospace and other expensive equipment. One of the reasons for the high price of these composite materials is the long time required for their manufacture.

Some of the most commonly used methods of producing fiber-reinforced polymer composites include the use of thermoset resins. This is in part, because of thermoset resins' low viscosity which results in easier production of fiber composites having higher strength at a wider temperature range. However, generally thermoset resins need a lot of time to reach the sufficient strength needed to maintain their shape and be removable. As a result, they sometimes need to remain in the die/mold for long periods of up to a few hours. Hence, the amount of time needed for producing fiber-reinforced polymer composites having thermoset resins is generally long and productivity is low.

There are several known methods for producing fiber-reinforced polymer composites with continuous fibers. These methods include hand layup, resin transfer molding (RTM), autoclave, pultrusion and thermo-stamping. Each of these processes has some disadvantages that will be discussed in more detail below.

In the hand layup process, reinforcement ply is manually placed on the mold and the laminating resin is applied. Then rollers are used to consolidate the laminate, thoroughly wetting the reinforcement and removing entrapped air. Subsequent layers of reinforcement are added to build laminate thickness. Then the next mold is placed on top of the laminate or alternatively, a vacuum bag is used to create a vacuum. The laminate is then cured either at ambient temperature or inside a furnace. Because of the amount of labor and time required for using this method, the method was more commonly used in the past due to the limited equipment and technology. However, this method may still be used if the shape of the part is very complex or the required number of composite parts are very few. However, the time required to produce a composite part using this method is very long.

In the RTM process, fiber preform or dry fiber reinforcement is packed into a mold cavity that has the shape of the desired part. The mold is then closed and clamped. Low viscosity resin is then pumped into the mold under pressure, until the mold is filled. Then, a cure cycle starts during which the mold is heated, until the resin becomes fully cured. Afterwards the part can be removed from the mold. This RTM process includes subcategories such as vacuum assisted resin transfer molding (VARTM), Seemann's composite resin infusing molding process (SCRIMP), vacuum induced preform relaxation (VIPR) and compression resin transfer molding (CRTM). These processes are in general similar to the RTM process and require full curing of the fiber-reinforced polymer composite part before it can be demolded, and as such require a long production time.

The autoclave process is commonly used for producing parts that require high quality and performance. In this process, thin layers of high modulus fiber impregnated with partially cured resin (referred as prepreg) are cut and stacked to form a component of desired shape. Subsequently, the stack is covered with various layers of cloth (bleeder and breather) and sealed inside a vacuum bag. After sealing, the tool-laminate assembly is placed inside an autoclave. In the autoclave, the air inside the vacuum bag is evacuated through a vacuum pump, the space inside the autoclave is filled with a high-pressure gas and the temperature rises to allow the curing process to take place. The fiber-reinforced composite has to remain in the autoclave until fully cured which requires a long production time.

The pultrusion process is a continuous process with a relatively high production rate. However, this process is generally limited to production of parts with a constant cross-section, such as sheets and beams. The process starts with pulling of reinforcing fiber in the forms of continuous rovings or mats from a series of creels. The fibrous material is fed continuously through a guiding system into a resin bath to get it impregnated. Subsequently, after completing a pre-heating process, they enter the main mold, where the fiber-reinforced composite parts are shaped and cured. In one implementation, after the part is cured, a cutting tool cuts the part into the desired shape.

In the process of thermo-stamping, laminated fibers, which are either previously impregnated with resin or impregnated locally, are placed in a die and are formed to desired shapes by application of a punch. In general, the punch remains on the part for a sufficiently long period to cure it at a high temperature. This requires a long time due to the long cure cycle of the resin.

To reduce the production time of a part using the above described methods, many attempts have been made to investigate resin structure in order to reduce curing time, improve process parameters, and use new techniques in the manufacturing process. However, in all of the improved methods, removal of the part from the mold/die requires full curing of resin. As a result, the fiber-reinforced polymer composite part needs to remain in the mold/die for a long period of time. Thus, the amount of time required for producing fiber-reinforced thermosetting composites is long and productivity is low.

A solution is proposed here to solve these issues and more by providing an improved method and system for producing fiber-reinforced polymer composites which includes utilizing metal composite components. In one implementation, the process involves placing pieces of metal components between layers of fiber during the layup and impregnating process. The type, shape and amount of the metal components chosen depend on the final desired shape and properties of the fiber-reinforced polymer composite. In one implementation, the layers are impregnated with a bonding material such as thermoset resin. In one implementation, after the layup process, the laminate is transferred to the die and is punched to desired shape. In the currently known methods of production, the part would need to remain in the mold, at this stage, until it is completely cured. However, using the preferred implementation discussed here, the fiber-reinforced polymer composite part can be removed from the die upon being semi-cured. This is because the metal components placed inside the part make the final part retain its shape upon being only semi-cured. As a result, the part can be removed sooner, thus reducing the amount of time required for production. Thus, the solution provided by the preferred embodiment of the present invention increases the speed of production thereby increasing production efficiency, reducing cost, and resulting in a better and higher quality final product.

In one implementation, the improved method of producing fiber-reinforced polymer composites can be used in the process of stamping to speed the production of parts, thus resulting in increased production efficiency, and ultimately leading to lower costs and increased use of these composites in various industries.

In one implementation, the improved method of producing fiber-reinforced polymer composites involves placing metal components in predetermined directions in between layers of fiber, during the layup and impregnating stage of production. The metal components can be selected based on the final shape and properties of the fiber-reinforced polymer composite part. In one implementation, the metal component is a piece of wire. Alternatively, the metal component can be in the form of a strip, a sheet, a net, or any other suitable shape. The metal component may be made from aluminum, magnesium, steel, copper or any other metal which satisfies the requirements.

In one implementation, the layup is done according to design requirements and the final shape and geometry of the part. The resin-impregnated layers are then formed into a desired shape by using a commonly used forming technique such as stamping. In conventional methods, at this stage of the process, the part remains in the die/mold until the curing process is completely done. However, using the improved method of production disclosed herein, the part does not need to remain in the die for a long time to be completely cured. Instead, the fiber-reinforced polymer composite part can be removed after a short period of time, while it is still semi-cured. The metal components placed inside the part make it retain its shape in the same form upon being removed, even though it is not fully cured. This means that the part can be removed from the die sooner than before and the die can be immediately used for a next part.

In one implementation, the removed part is cured in a furnace or ambient temperature, according to its design requirements and/or resin properties. Thus, the production time of a fiber-reinforced polymer composite part is reduced and production efficiency is significantly increased.

It should be noted that the implementations of the present invention can also be used in the production of pre-impregnated materials (so-called prepregs). Pre-impregnated composites are generally materials that are only partially cured to allow easy handling and require cold storage to prevent complete curing. These materials can be used in a variety of processes. The improved method for producing fiber-reinforced polymer composites disclosed herein can be used with such pre-impregnated composites by using metal components during the production of prepregs.

In one implementation, hybrid processes are used to further improve production efficiency. For example, the processes of pultrusion and stamping can be combined with the improved method for producing fiber-reinforced polymer composites disclosed herein. Pultrusion is a process that continuously produces composite profiles such as sheets. In one implementation, during the pultrusion process, in addition to the fiber strands, metal components such as metal wires are fed to the machine to produce a 3-component semi-cured sheet. In one implementation, the semi-cured sheet containing metal wires is then transferred to a stamping machine to perform a stamping process followed by curing the component in a furnace to produce the final product. By automating and/or mechanizing these processes, composite components can be produced at very high speeds and thus low prices.

Thus, the solution provided by the preferred embodiment of the present invention to manufacture parts made from fiber composite materials provides a process that includes using metal components to form semi-cured composite parts that can be removed from a mold. This increases the speed of production of the part, thereby increasing the production efficiency and reducing the cost of the final product.

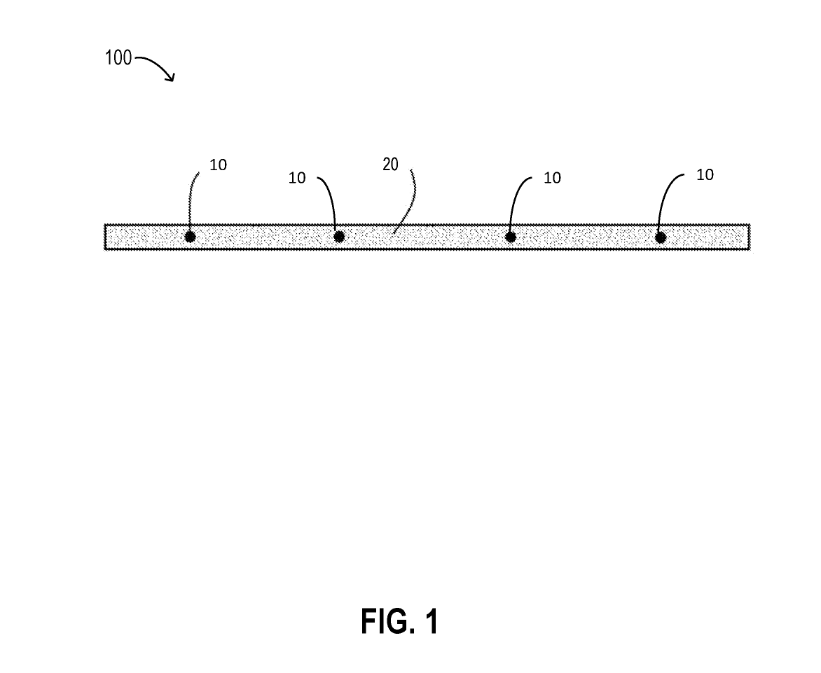

Referring now to the drawings, FIG. 1 illustrates one implementation of a cross section of a fiber-reinforced polymer composite piece 100 produced according to an implementation of the present invention. As can be seen, the fiber-reinforced polymer composite piece 100, includes a plurality of metal components 10 that are interposed in between resin-impregnated fiber materials 20. The fiber-reinforced polymer composite piece 100 shows a plurality of metal components 10 that are located in between equally spaced resin-impregnated fiber layers. Other implementations are possible. For example, depending on the shape and desired characteristics of the final part, metal components can be placed more closely at the top or in the bottom of portion of the fiber-reinforced polymer composite part.

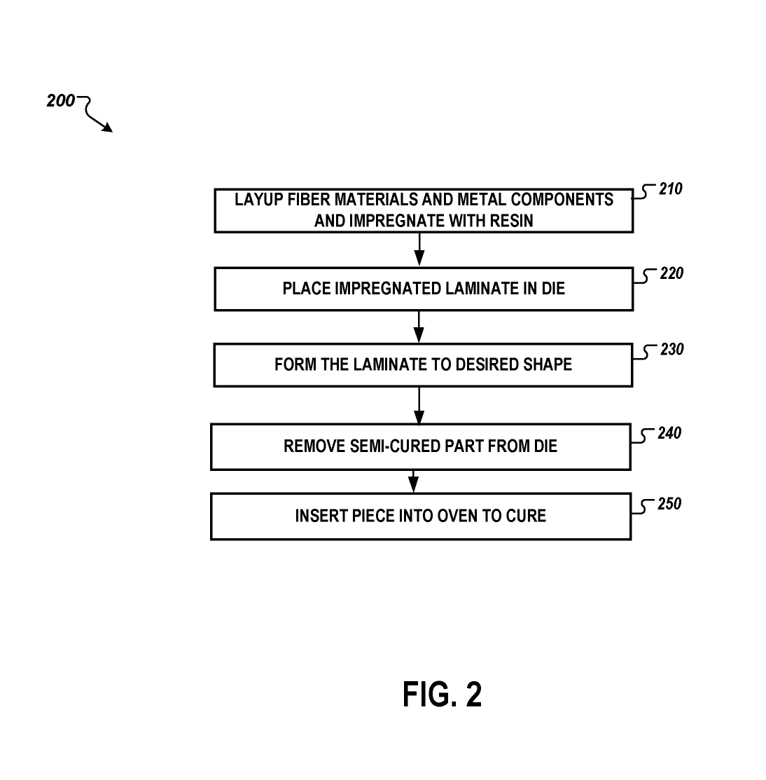

FIG. 2 illustrates a diagram of a flow of example operations for an improved process 200 for producing a fiber-reinforced polymer composite part, according to an implementation. In one implementation, the improved operation 200 begins by laying up fiber materials and metal components and impregnating them with resin, at 210. This requires that a determination be made as to the optimal type, size and shape of the metal components needed. In general, the dimensions of the metal components are selected based on the desired shape and properties of the final composite part. In one implementation, this means that the dimensions of the metal component (e.g., diameter of wires, thickness of sheets, or thickness and width of strips) are chosen to provide the required bend strength while ensuring that desired composite properties are not affected. For example, adding metal components often reduces the specific strength of fiber-reinforced polymer composites. Thus, the metal component should be selected such that its addition does not substantially reduce the specific strength of the produced fiber-reinforced polymer composite part.

In one implementation, the metal component is selected from the group of aluminum, magnesium, titanium, or a combination of these metals. To ensure that the final part does not lose its desired properties of a fiber-reinforced polymer composite, in one implementation, the percentage of the metal component used is no more than 30% of the entire volume of the final part. In general, the type and dimension of the metal components are chosen such that the least amount of metal materials needed to achieve the desired result of allowing a semi-cured composite part to be removed from a die is used. This may be done through calculations or by trial and error.

It should be noted that the use of metal components is not intended for increasing load bearing, however, a side effect of using metal components may be increase in impact resistance and prevention of cracks.

In one embodiment, to prepare the surface of the metal components for adhesion between the metal components and the resin, known methods such as degreasing and dry surface treatment are used. Degreasing may be done by using solutions such as dichloromethane, perchloroethylene, trichloroethylene, methyl ethyl ketone, methanol or isobutanol. In one implementation, the surface is prepared using one or more of the following treatments: grit-blasting; etching using chromic acid or sulfuric acid; etching using alkaline solutions; anodizing with chromic acid, sulfuric acid, phosphoric acid or boric acid; using coupling agent techniques, i.e., silane or sol-gel; excimer laser texturing; plasma sprayed coating; and ion beam enhanced deposition (IBED).

In one implementation, mechanical properties of the final composite part can be calculated from rules of mixtures using the following equations, when only one type of metal component is used:

$$\begin{matrix}{σ}_{ult}^{lam} = {V}_{f}^{m} {σ}_{ult}^{m} + ( 1 - {V}_{f}^{m} ) {σ}_{ult}^{p} & ( 1 ) \\ {E}_{11}^{lam} = {V}_{f}^{m} {E}^{m} + ( 1 - {V}_{f}^{m} ) {E}^{p} & ( 2 ) \\ \frac{1}{{E}_{22}^{lam}} = \frac{{V}_{f}^{m}}{{E}^{m}} + \frac{( 1 - {V}_{f}^{m} )}{{E}^{p}} & ( 3 ) \\ \frac{1}{{G}_{12}^{lam}} = \frac{{V}_{f}^{m}}{{G}^{m}} + \frac{( 1 - {V}_{f}^{m} )}{{G}^{p}} & ( 4 )\end{matrix}$$

where σ₁₁^{lam} is the ultimate strength of the laminate (final part), V_{f}^{m} is the percentage in volume of the metal component, σᵤₗₜ^{m} is the ultimate strength of the metal component, and σᵤₗₜ^{p} is the ultimate strength of the FRP part. In equation (2), E₁₁^{lam} represents the elastic laminate modulus in the longitudinal direction of the fibers, E^{m} represents the elastic modulus of the metal component and E^{p} represents the elastic modulus of the FRP part. In equation (3), E₂₂^{lam} represents the elastic modulus of the laminate in the long transverse fibers direction and in equation (4), G₁₂^{lam} represents the shear modulus for the laminate in 1-2 plane, G^{m} represents the shear modulus for the metal component, and G^{p} represents the shear modulus for the FRP part.

After the type, amount and dimensions of the metal components are selected and the surface is prepared, operation 200 of FIG. 2 begins by placing fiber layers and metal components in a particular order to produce a composite part that exhibits particular desired properties and impregnating with a thermosetting resin. The impregnation process can be performed during the layup after placing each layer, or alternatively after layup by a resin infusion process. After layup and impregnation are complete, the impregnated laminate is placed in a die, at 220, before the laminate is formed to a desired shape, at 230. In one implementation, at this stage, after forming its desired shape, the composite may remain in the die for a short time period so that it can be semi-cured, before it is removed from the die at 240. The duration of this period may depend on the shape, size and particular properties of the composite part. However, in general the required period of time is much shorter than the amount of time required to fully cure a part. The presence of the metal components allows the part to be removed from the die while semi-cured.

In one implementation, after the semi-cured composite part is removed from the die, it is inserted into a furnace or an oven to fully cure it, at 250. Alternatively, after being removed, the composite part can stay in the ambient environment to be cured on its own. This frees the die to be used for the next part, thus reducing the amount of time required for production and substantially saving time and reducing cost.

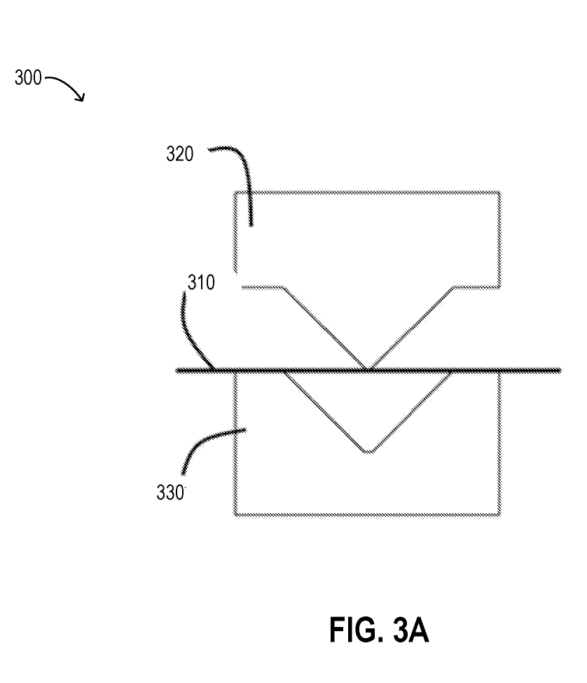

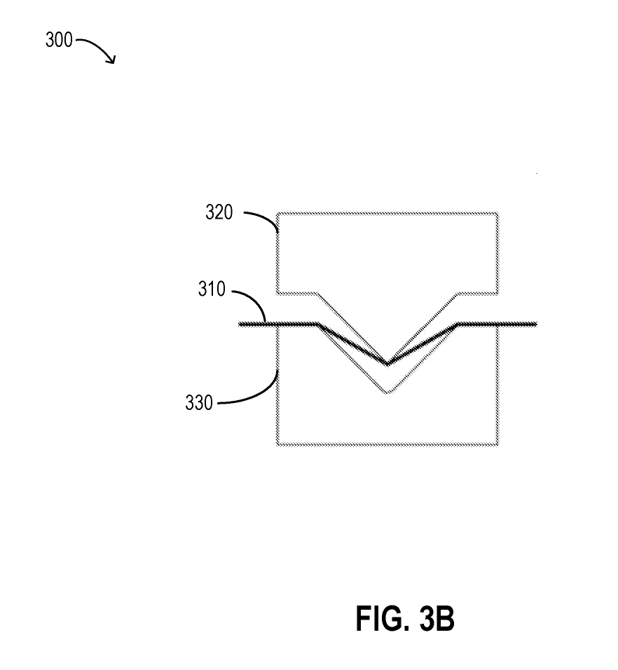

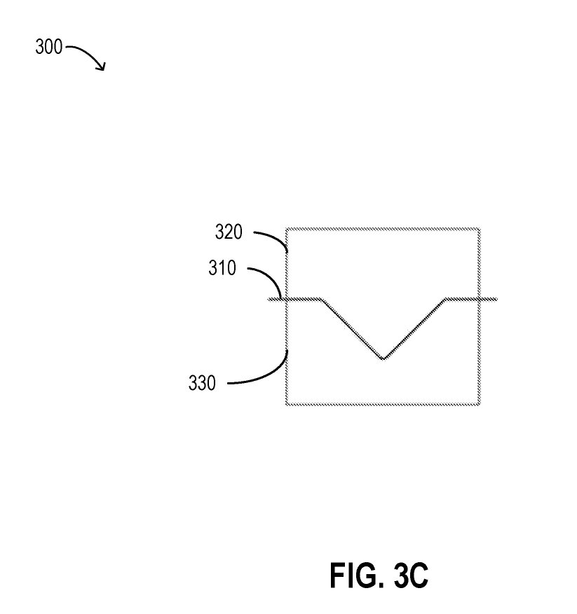

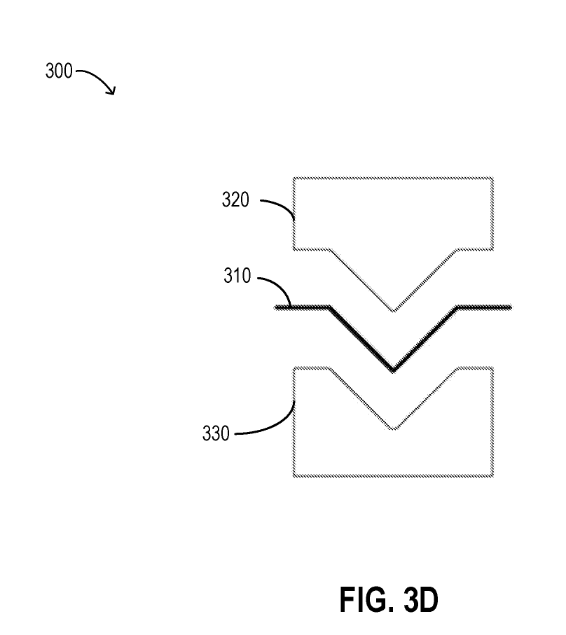

FIGS. 3A-3D illustrate schematic diagrams of various stages of forming a fiber-reinforced polymer composite part when using a stamping process, according to an implementation. FIG. 3A illustrates the first step in the process of forming a laminate composite 310 using a stamping device 300. In one implementation, the stamping device 300 includes a punch 320 and a die 330, which are complementary and configured such that the composite piece 310 can be formed to a desired shape. In one implementation, the laminate composite 310 is a semi-cured fiber-reinforced polymer composite piece containing metal components. The laminate composite 310 may first be prepared using one or more steps of the improved process for producing a fiber-reinforced polymer composite part discussed above. For example, the laminate composite 310 may be prepared by the layup and impregnation process in a flat mold that subsequently uses pressure and by allowing the laminate composite 310 to stay in the flat mold until the resin is semi-cured. Once the resin is sufficiently cured, the semi-cured laminate composite 310 is removed from the die and transferred to the stamping device 300 to be formed. In one implementation, prior to being transferred to the stamping device 300, the semi-cured laminate composite 310 is cut into a desired size.

FIG. 3B illustrates the next step in the process of shaping the laminate composite 310 using the stamping device 300. As shown, the punch 320 gradually moves down and as it does, it forms the laminate composite 310 into the shape of the die 330. In an alternative configuration, instead of the punch 320 moving down, the die 330 moves up. In yet another alternative implementation, punch 320 and die 330 move towards each other. This may be done manually or automatically.

FIG. 3C illustrates yet another step in the process of forming the laminate composite 310 using the stamping device 300. In the configuration shown in FIG. 3C, the punch 320 has completely moved down into the die 330 and the laminate composite 310 has moved with the punch 320 to fit in between the punch 320 and the die 330.

FIG. 3D illustrates the shape of the laminate composite 310 after remaining inside the stamping device 300 for a specific period of time to take its desired shape. Once the punch 320 and/or the die 330 move away from each other, the laminate composite 310 has formed its desired shape, as shown. In one implementation, once the laminate composite 310 is removed from the stamping device 300, it is moved to an oven to be fully cured. Alternatively, the laminate composite 310 may be placed on an appropriate surface to be cured in the ambient environment.

Accordingly, the solution provided by the improved method of producing fiber-reinforced composite materials provides a process that includes using metal components to from semi-cured composite parts that can be removed from a die/mold before being fully cured. This increases the speed of production of the part, thereby increasing production efficiency and reducing the cost of the final product.

The separation of various components in the examples described above should not be understood as requiring such separation in all examples, and it should be understood that the described components and systems can generally be integrated together in a single packaged into multiple systems.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various implementations for the purpose of streamlining the disclosure. This method of disclosure is not to be interpreted as reflecting an intention that the claimed implementations require more features than are expressly recited in each claim. Rather, as the following claims reflect, inventive subject matter lies in less than all features of a single disclosed implementation. Thus the following claims are hereby incorporated into the Detailed Description, with each claim standing on its own as a separately claimed subject matter.

What is claimed is:

1. A method for producing a fiber-reinforced composite part, comprising:
placing a plurality of fibers and at least one metal component in one or more layers;
impregnating the one or more layers with at least one bonding material disposed on the one or more layers;
placing the impregnated one or more layers in a die until a semi-cured fiber-reinforced composite part is formed; and
removing the semi-cured fiber-reinforced composite part from the die.

2. The method for producing a fiber-reinforced composite part of claim 1, wherein the bonding material includes a thermoset resin.

3. The method for producing a fiber-reinforced composite part of claim 1, further comprising inserting the semi-cured fiber-reinforced composite part into an oven to fully cure.

4. The method for producing a fiber-reinforced composite part of claim 1, further comprising leaving the semi-cured fiber-reinforced composite part in an ambient environment to fully cure.

5. The method for producing a fiber-reinforced composite part of claim 1, wherein the at least one metal component is selected from the group comprising aluminum, magnesium, titanium, steel, copper, or a combination thereof.

6. The method for producing a fiber-reinforced composite part of claim 1, wherein at least one of a type and dimension of the at least one metal component is selected based on one or more desired properties of the fiber-reinforced composite part.

7. The method for producing a fiber-reinforced composite part of claim 1, further comprising forming the semi-cured fiber-reinforced composite part using a stamping process.

8. The method for producing a fiber-reinforced composite part of claim 1, further comprising forming the semi-cured fiber-reinforced composite part using a stamping device.

9. The method for producing a fiber-reinforced composite part of claim 1, wherein the at least one metal component takes up 30% or less of a total volume of the fiber-reinforced composite part.

10. The method for producing a fiber-reinforced composite part of claim 1, further comprising removing any excess bonding material from the one or more layers.
